(19) United States
(12) Patent Application Publication
(10) Pub. No.: US 2021/0342081 A1
(43) Pub. Date: Nov. 4, 2021

(54) COMPUTING SYSTEM AND OPERATING METHOD THEREOF

(71) Applicant: ELECTRONICS AND TELECOMMUNICATIONS RESEARCH INSTITUTE, Daejeon (KR)

(72) Inventors: Song-Woo SOK, Daejeon (KR); Jin-Suk MA, Daejeon (KR)

(73) Assignee: ELECTRONICS AND TELECOMMUNICATIONS RESEARCH INSTITUTE, Daejeon (KR)

(21) Appl. No.: 17/241,503

(22) Filed: Apr. 27, 2021

(30) Foreign Application Priority Data
Apr. 29, 2020 (KR) 10-2020-0052591

(51) Int. Cl. G06F 3/06

(52) U.S. Cl. CPC G06F 3/0635; G06F 3/061; G06F 3/0683; G06F 3/0659; G06F 3/0658

(57) ABSTRACT

A computing system and operating method thereof may be disclosed. The computing system may include a storage device configured to provide a direct access interface and an indirect access interface, an access interface configurator configured to determine whether to use one of the direct access interface and the indirect access interface according to input/output characteristics of an application program, and a processor configured to access the storage device according to the determined access interface.

### CROSS-REFERENCE TO RELATED APPLICATION

This application claims priority to and the benefit of Korean Patent Application No. 10-2020-0052591 filed in the Korean Intellectual Property Office on Apr. 29, 2020, the entire contents of which are incorporated herein by reference.

### BACKGROUND OF THE INVENTION

### (a) Field of the Invention

The following description relates to a computing system and an operating method thereof.

### (b) Description of the Related Art

A general computing system has a memory hierarchy structure such as CPU registers, caches (L1, L2, L3), main memory, and storage devices (SSD, HDD, tape, etc.). In such a memory hierarchy structure, the performance difference between the main memory and the storage device is very large, and recently, a new memory hierarchy such as persistent memory (PMEM) or storage class memory (SCM) has been introduced.

PMEM or SCM maintains storage contents like storage devices (SSD, HDD) even after turning the power off and then on, and can read and write data by directly accessing it in units of size smaller than the block unit (e.g., 512 bytes).

Some PMEMs or SCMs provide two access interfaces that can directly access an address area to perform I/O (input/output) or indirectly perform I/O using a controller interface.

When a memory provides a direct access interface and an indirect access interface at the same time, performance characteristics may differ according to the two interface methods. In general, the direct access interface provides low latency for small data input/output. On the other hand, the indirect access interface supports a direct memory access (DMA) function where the input/output device directly reads and writes data to the main memory, and provides high bandwidth for large data sizes.

According to the data access characteristics of an application program to be executed using such PMEM or SCM, a direct access interface or an indirect access interface needs to be selectively applied for performance optimization.

The above information disclosed in this Background section is only for enhancement of understanding of the background of the invention, and therefore it may contain information that does not form the prior art that is already known in this country to a person of ordinary skill in the art.

### SUMMARY OF THE INVENTION

At least one of the embodiments may provide a computing system and operating method that optimize performance by automating selection of an access interface.

In one aspect, a computing system may be provided. the computing system may include a storage device configured to provide a direct access interface and an indirect access interface, an access interface configurator configured to determine whether to use one of the direct access interface and the indirect access interface according to input/output characteristics of an application program, and a processor configured to access the storage device according to the determined access interface.

The access interface configurator may compare data size of the application program with a predetermined threshold, and determines whether to use one of the direct access interface and the indirect access interface according to the comparison result.

When the application program requests a read operation, the predetermined threshold may be a read threshold, and when the application program requests a write operation, the predetermined threshold may be a write threshold.

The access interface configurator may include a boundary value measuring device configured to determine the predetermined threshold using a first delay time measured by applying the direct access interface for each data size and a second delay time measured by applying the indirect access interface for each data size.

The boundary value measuring device may compare the first delay time with the second delay time, and determines a data size at which the delay times are reversed as the predetermined threshold value.

The computing system may further include an initial value setter configured to set a minimum data size and a maximum boundary value that can be used in the storage device, and the boundary value measuring device may increase data size from the minimum data size to the maximum boundary value and measures the first and second delay times.

The computing system may further include a memory controller configured to control the indirect access interface between the storage device and the processor.

The direct access interface may be a method in which the processor directly accesses the storage device, and the indirect access interface may be a method in which the processor accesses the storage device through the memory controller.

The access interface setter may determine to use the direct access interface when the data size is less than or equal to the predetermined threshold value, and use the indirect access interface when the data size is larger than the predetermined threshold value.

The storage device may be a persistent memory (PM) or a storage class memory (SCM).

In another aspect, a method for operating a computing system including a storage device that provides a direct access interface and an indirect access interface may be provided. The method may include: determining the direct access interface or the indirect access interface according to input/output characteristics of an application program when there is a call of the application, wherein the application uses the direct access interface and the indirect access interface; and accessing the storage device according to the determined access interface.

The input/output characteristics may be data size of the application program.

The determining may include comparing the data size with a predetermined threshold, determining the direct access interface when the data size is less than or equal to the predetermined threshold, and determining the indirect access interface when the data size is larger than the predetermined threshold.

The method may further include measuring a first delay time by using the direct access interface for each data size, measuring a second delay time by using the indirect access interface for each data size, and determining the predetermined threshold by comparing the first delay time and the second delay time.

The direct access interface may be a method in which a processor included in the computing system directly accesses the storage device, and the indirect access interface may be a method of accessing the storage device through a memory controller included in the computing system.

The storage device may be a persistent memory (PM) or a storage class memory (SCM).

In another aspect, a method for operating a computing system including a storage device that provides a direct access interface and an indirect access interface may be provided. The method may include comparing data size of an application program with a predetermined threshold when there is a call of the application program, accessing the storage device through the direct access interface when the data size is less than or equal to the threshold value, and accessing the storage device through the indirect access interface when the data size is larger than the predetermined threshold.

The direct access interface may be a method in which a processor included in the computing system directly accesses the storage device, and the indirect access interface may be a method of accessing the storage device through a memory controller included in the computing system.

The storage device may be a persistent memory (PM) or a storage class memory (SCM).

According to at least one aspect, optimal input/output performance can be achieved by selectively applying a direct access interface or an indirect access interface according to input/output characteristics of an application program.

### BRIEF DESCRIPTION OF THE DRAWINGS

FIG. 1 is a block diagram showing a computing system according to one embodiment.

FIG. 2 is a block diagram showing an access interface configurator according to one embodiment.

FIG. 3 is a flowchart showing a method of operating a boundary value measuring device 112 according to one exemplary.

FIG. 4 is a flowchart showing a read operation of the input/output processor 113 according to one embodiment.

FIG. 5 is a flowchart showing a write operation of the input/output processor 113 according to one embodiment.

### DETAILED DESCRIPTION OF THE EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness. The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween. As used herein, the term “and/or” includes any one and any combination of any two or more of the associated listed items. Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples. Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly. The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. The features of the examples described herein may be combined in various ways as will be apparent after an understanding of the disclosure of this application. Further, although the examples described herein have a variety of configurations, other configurations are possible as will be apparent after an understanding of the disclosure of this application. In addition, unless explicitly described to the contrary, the word “comprise” and variations such as “comprises” or “comprising” will be understood to imply the inclusion of stated elements but not the exclusion of any other elements.

A computing system according to one embodiment may select a direct access interface or an indirect access interface according to input/output characteristics such as input/output data size or frequency of an application program so that applications using storage devices such as PMEM or SCM can achieve optimal performance. For application programs with complex input/output characteristics, optimal performance may not be achieved with only one interface. The direct access interface has the advantage of having a short delay time when inputting and outputting data of a small size, and the indirect access interface has the advantage of providing a high bandwidth when inputting and outputting the large size of data. Accordingly, a computing system according to one embodiment can achieve optimum performance by selectively using a direct access interface and an indirect access interface according to input/output characteristics of an application program. Hereinafter, a computing system and an operating method thereof according to one embodiment will be described in detail.

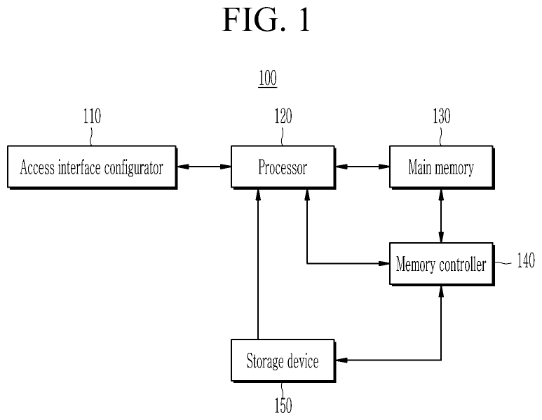

FIG. 1 is a block diagram showing a computing system according to one embodiment.

As shown in FIG. 1, the computing system 100 according to one embodiment includes an access interface configurator 110, a processor 120, a main memory 130, a memory controller 140, and a storage device 150.

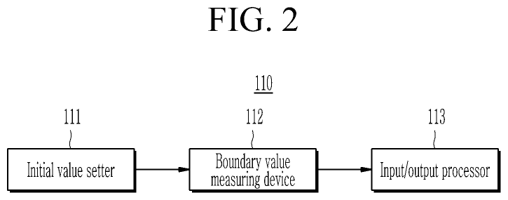

When the called application program is an application program using the storage device 150, the access interface configurator 110 according to one embodiment determines an access method to be used for input/output of the application program. Here, the access method includes a direct access interface and an indirect access interface. The access interface configurator 110 includes an initial value setting step, a boundary value measuring step, and an input processing step, and a detailed description thereof will be described in more detail with reference to FIG. 2 below. The access interface configurator 110 may be implemented through a device driver or a user library in a layer of a computer system.

The processor 120 executes a corresponding command according to the command of the access interface configurator 110. The processor 120 according to an embodiment performs input/output of a memory according to the access method input (requested) from the access interface configurator 110. The processor 120 may be a central processing unit (CPU).

In order to process a data and store the result, the processor 120 fetches the data into the register inside the processor 120, processes it, and stores the processed result in memory. The storage device 150 according to one embodiment supports a direct access interface and an indirect access interface as a method of fetching or storing data. Hereinafter, a method of operating the processor 120 according to the direct access interface and the indirect access interface input from the access interface configurator 110 will be described.

First, a case in which a request (command) of a direct access interface is input from the access interface configurator 110 will be described. When a request (command) of a direct access interface is input, the processor 120 directly moves data between a register in the processor 120 and the storage device 150. At this time, the processor 120 directly accesses the address of the storage device 150 in which data are stored or are to be stored, and reads or writes data.

Next, a case in which a request (command) of an indirect access interface is input from the access interface configurator 110 will be described. In this case, there is a slight difference between the process of reading data and the process of writing data.

First, the process of reading data is as follows. When a request (instruction) of an indirect access interface is input, the processor 120 inputs an address (or block number) in the storage device 150 of the data to be read and an address in the main memory 130 to be read and stored to the memory controller 140. At this time, the processor 120 requests direct memory access (DMA) from the storage device 150 to the main memory 130 to the memory controller 140. The memory controller 140 reads the data of the corresponding address from the storage device 150, stores it in the address of the main memory 130, and generates an interrupt. The processor 120 receives a completion interrupt and reads data from the corresponding address of the main memory 130 into a register.

Second, the process of writing data is as follows. When a request (instruction) of an indirect access interface is input, the processor 120 copies data to be stored in the storage device 150 from a register to an address in the main memory 130. The processor 120 inputs the address of the main memory 130 of the stored data and the address (or block number) of the storage device 150 to be stored to the memory controller 140. At this time, the processor 120 requests direct memory access (DMA) from the main memory 130 to the storage device 150 to the memory controller 140. The memory controller 140 reads data from the address of the main memory 130, stores it in the corresponding address of the storage device 150, and generates an interrupt. When processor 120 receives a completion interrupt, this process is terminated.

The main memory 130 stores data necessary to perform the operation of the processor 120. The main memory 130 may be implemented as a random access memory (RAM).

The storage device 150 according to one embodiment is a storage device that provides both a direct access interface capable of input/output at a byte level and an indirect access interface capable of input/output at a block unit. The storage device 150 may be a nonvolatile or volatile storage device or memory. The storage device 150 may be a persistent memory (PM) or a storage class memory (SCM).

The memory controller 140 performs a control role between the processor 120 and the storage device 150 to provide an indirect access interface. When the storage device 150 is a persistent memory (PM), the memory controller 140 may be a persistent memory controller. In addition, when the storage device 150 is a storage class memory (SCM), the memory controller 140 may be a storage class memory controller.

FIG. 2 is a block diagram showing an access interface configurator 110 according to one embodiment.

As shown in FIG. 2, the access interface configurator 110 according to one embodiment includes an initial value setter 111, a boundary value measuring device 112, and an input/output processor 113.

The initial value setter 111 performs an initial value setting step. The initial value setter 111 receives a minimum unit data size (Sₘᵢₙ) and a maximum boundary value (Sₘₐₓ) that can be input/output from a user, and stores Sₘᵢₙ and Sₘₐₓ in a configuration file. Here, the configuration file may be stored in a separate storage device (e.g., SSD, HDD, tape, etc.) not shown in FIGS. 1 and 2. The Sₘᵢₙ value may be determined according to a minimum input/output data size of the indirect access interface supported by the storage device 150. In addition, the Sₘₐₓ value may be set to an appropriate value according to a situation of the computing system 100 among multiples of the Sₘᵢₙ value. Meanwhile, the initial value setter 111 may set a path for a direct access interface and a path for an indirect access interface by a user.

The boundary value measuring device 112 measures a read threshold value and a write threshold value by using the initial value (Sₘᵢₙ, Sₘₐₓ) set by the initial value setter 111.

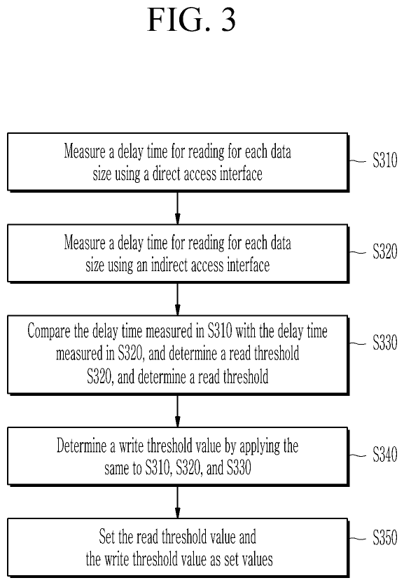

FIG. 3 is a flowchart showing a method of operating a boundary value measuring device 112 according to one exemplary.

First, the boundary value measuring device 112 measures a delay time for reading for each data size using a direct access interface (S310). The boundary value measuring device 112 performs a read operation through a direct access interface while increasing the data size to Sₘₐₓ by a multiple of Sₘᵢₙ (Sₘᵢₙ, 2Sₘᵢₙ3Sₘᵢₙ, . . . ), and measures a delay time generated during the read operation for each data size. Here, an actual execution of the read operation through the direct access interface is performed by the processor 120 performing the read operation through the direct access interface method described above in response to a command (request) of the boundary value measuring device 112.

The boundary value measuring device 112 measures a delay time for reading for each data size using an indirect access interface (S310). The boundary value measuring device 112 performs a read operation through an indirect access interface while increasing the data size to Sₘₐₓ by a multiple of Sₘᵢₙ (Sₘᵢₙ, 2Sₘᵢₙ, 3Sₘᵢₙ, . . . ), and measures a delay time generated during the read operation for each data size. Here, an actual execution of the read operation through the direct access interface is performed by the processor 120 performing the read operation through the indirect access interface method described above in response to a command (request) of the boundary value measuring device 112.

The boundary value measuring device 112 compares the delay time measured in S310 with the delay time measured in S320, and determines a read threshold (S330). That is, the boundary value measuring device 112 compares the delay time for each data size measured in S310 with the delay time for each data size measured in S320 to find the data size at which the delay time is reversed. Here, the data size at which the delay time is reversed is the read threshold value (S_{read_threshold}).

Also for writing, the boundary value measuring device 112 determines a write threshold value (S_{wirte_threshold}) by applying the same to S310, S320, and S330 (S340). The boundary value measuring device 112 measures a delay time for writing for each data size using a direct access interface. The boundary value measuring device 112 measures a delay time for writing for each data size using an indirect access interface. The boundary value measuring device 112 compares the delay time for each data size measured in the direct access interface and the delay time for each data size measured in the indirect access interface to find the data size at which the delay time is reversed. Here, the data size at which the delay time is reversed is the write threshold value (S_{wirte_threshold}).

The boundary value measuring device 112 sets the read threshold value (S_{read_threshold}) determined in S330 and the write threshold value (S_{wirte_threshold}) determined in S340 as set values (S350). Such set values are set as internal variables of a device driver or a user library and can be used continuously during an execution time of the device driver or user library.

Meanwhile, the measurement of the delay time and the setting of the threshold value by the boundary value measuring device 112 may be performed during an initialization process when the device driver or the user library is executed.

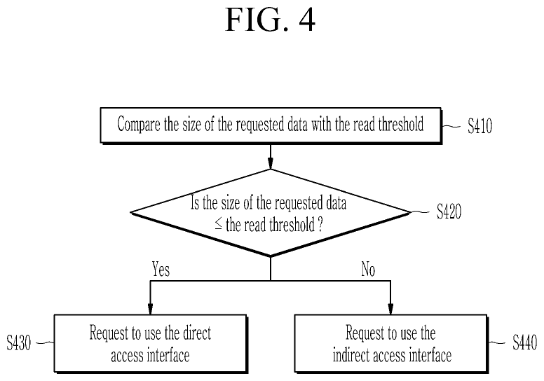

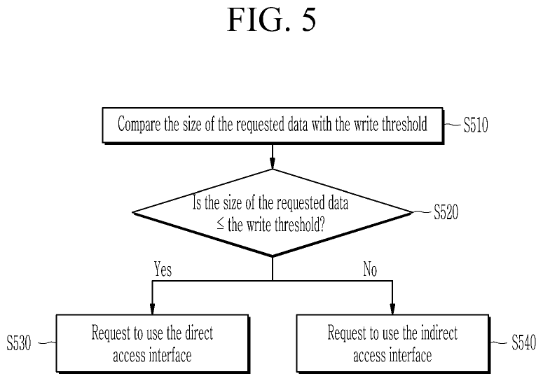

When there is a data read request from the application program, the input/output processor 113 determines whether to use a direct access interface or an indirect access interface according to the size of the requested data. The input/output processor 113 requests the processor 120 for an access interface corresponding to the determined result. In addition, when there is a data write request from the application program, the input/output processor 113 determines whether to use a direct access interface or an indirect access interface according to the size of the requested data. The input/output processor 113 requests the processor 120 for an access interface corresponding to the determined result. The detailed operation of the input/output processor 113 will be described in more detail with reference to FIGS. 4 and 5 below.

FIG. 4 is a flowchart showing a read operation of the input/output processor 113 according to one embodiment.

When receiving a request for reading data from an application program, the input/output processor 113 compares the size of the requested data with the read threshold (S410). That is, when there is a read request from the application program, the input/output processor 113 compares the data size corresponding to the read request with the read threshold (S_{read_threshold}) set by the boundary value measuring device 112.

When the size of the requested data is less than or equal to the read threshold as a result of the comparison in S410, the input/output processor 113 requests the processor 120 to use the direct access interface (S420, S430). Here, when the processor 120 receives a request to use the direct access interface from the input/output processor 113, the processor 120 accesses the storage device 150 through the direct access interface and performs a read operation.

When the size of the requested data is greater than the read threshold as a result of the comparison in S410, the input/output processor 113 requests the processor 120 to use the indirect access interface (S420, S440). Here, when the processor 120 receives a request to use the indirect access interface from the input/output processor 113, the processor 120 accesses the storage device 150 through the indirect access interface and performs a read operation.

FIG. 5 is a flowchart showing a write operation of the input/output processor 113 according to one embodiment.

When receiving a request for write data from an application program, the input/output processor 113 compares the size of the requested data with the write threshold (S510). That is, when there is a write request from the application program, the input/output processor 113 compares the data size corresponding to the write request with the write threshold (S_{write_threshold}) set by the boundary value measuring device 112.

When the size of the requested data is less than or equal to the write threshold as a result of the comparison in S510, the input/output processor 113 requests the processor 120 to use the direct access interface (S520, S530). Here, when the processor 120 receives a request to use the direct access interface from the input/output processor 113, the processor 120 accesses the storage device 150 through the direct access interface and performs a write operation.

When the size of the requested data is greater than the write threshold as a result of the comparison in S510, the input/output processor 113 requests the processor 120 to use the indirect access interface (S520, S540). Here, when the processor 120 receives a request to use the indirect access interface from the input/output processor 113, the processor 120 accesses the storage device 150 through the indirect access interface and performs a write operation.

The computing system according to one embodiment can achieve optimal input/output performance by selectively applying a direct access interface or an indirect access interface according to the size of the input/output data size of the application program.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A computing system comprising:
a storage device configured to provide a direct access interface and an indirect access interface;
an access interface configurator configured to determine whether to use one of the direct access interface and the indirect access interface according to input/output characteristics of an application program; and
a processor configured to access the storage device according to the determined access interface.

2. The computing system of claim 1, wherein
the access interface configurator compares data size of the application program with a predetermined threshold, and determines whether to use one of the direct access interface and the indirect access interface according to the comparison result.

3. The computing system of claim 2, wherein
when the application program requests a read operation, the predetermined threshold is a read threshold, and
when the application program requests a write operation, the predetermined threshold is a write threshold.

4. The computing system of claim 2, wherein
the access interface configurator includes
a boundary value measuring device configured to determine the predetermined threshold using a first delay time measured by applying the direct access interface for each data size and a second delay time measured by applying the indirect access interface for each data size.

5. The computing system of claim 4, wherein
the boundary value measuring device compares the first delay time with the second delay time and determines a data size at which the delay times are reversed as the predetermined threshold value.

6. The computing system of claim 4, further comprising
an initial value setter configured to set a minimum data size and a maximum boundary value that can be used in the storage device,
wherein the boundary value measuring device increases data size from the minimum data size to the maximum boundary value and measures the first and second delay times.

7. The computing system of claim 1, further comprising
a memory controller configured to control the indirect access interface between the storage device and the processor.

8. The computing system of claim 7, wherein
the direct access interface is a method in which the processor directly accesses the storage device, and
the indirect access interface is a method in which the processor accesses the storage device through the memory controller.

9. The computing system of claim 2, wherein
the access interface setter determines to use the direct access interface when the data size is less than or equal to the predetermined threshold value, and use the indirect access interface when the data size is larger than the predetermined threshold value.

10. The computing system of claim 1, wherein
the storage device is a persistent memory (PM) or a storage class memory (SCM).

11. A method for operating a computing system including a storage device that provides a direct access interface and an indirect access interface, the method comprising:
determining the direct access interface or the indirect access interface according to input/output characteristics of an application program when there is a call of the application, wherein the application uses the direct access interface and the indirect access interface; and
accessing the storage device according to the determined access interface.

12. The method of claim 11, wherein
the input/output characteristic is data size of the application program.

13. The method of claim 12, wherein
the determining includes:
comparing the data size with a predetermined threshold;
determining the direct access interface when the data size is less than or equal to the predetermined threshold; and
determining the indirect access interface when the data size is larger than the predetermined threshold.

14. The method of claim 13, further comprising:
measuring a first delay time by using the direct access interface for each data size;
measuring a second delay time by using the indirect access interface for each data size; and
determining the predetermined threshold by comparing the first delay time and the second delay time.

15. The method of claim 11, wherein
the direct access interface is a method in which a processor included in the computing system directly accesses the storage device, and
the indirect access interface is a method of accessing the storage device through a memory controller included in the computing system.

16. The method of claim 11, wherein
the storage device is a persistent memory (PM) or a storage class memory (SCM).

17. A method for operating a computing system including a storage device that provides a direct access interface and an indirect access interface, the method comprising:
comparing data size of an application program with a predetermined threshold when there is a call of the application program;
accessing the storage device through the direct access interface when the data size is less than or equal to the threshold value; and
accessing the storage device through the indirect access interface when the data size is larger than the predetermined threshold.

18. The method of claim 17, wherein
the direct access interface is a method in which a processor included in the computing system directly accesses the storage device, and
the indirect access interface is a method of accessing the storage device through a memory controller included in the computing system.

19. The of claim 17, wherein
the storage device is a persistent memory (PM) or a storage class memory (SCM).
